(19) United States
(12) Patent Application Publication
(10) Pub. No.: US 2008/0292931 A1
(43) Pub. Date: Nov. 27, 2008

(54) Membrane Electrode Assembly for Organic/Air Fuel Cells

(76) Inventors: Jo-Ann T. Schwartz, Avondale, PA (US); Harvey P. Tannenbaum, Wynnewood, PA (US); Vinci Martinez Felix, Kennett Square, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/158,421

(22) PCT Filed: Dec. 21, 2006
(86) PCT No.: PCT/US2006/048975

§ 371 Date: Jun. 20, 2008

Related U.S. Application Data
(60) Provisional application No. 60/753,229, filed on Dec. 21, 2005.

(51) Int. Cl. H01M 4/92; H01M 8/02; H01M 4/88

(52) U.S. Cl. 429/27; 429/40; 427/115

(57) ABSTRACT

The present invention provides a membrane electrode assembly for an organic/air fuel cell comprising a proton exchange membrane, an anode electrode, and a cathode electrode. The proton exchange membrane is made of a highly fluorinated ion-exchange polymer, and it has opposite first and second sides. The anode electrode is comprised of an anode electrocatalyst and a highly fluorinated ion-exchange polymer binder, and the anode electrocatalyst is comprised of platinum and ruthenium supported on particulate carbon. The cathode electrode is comprised of a cathode electrocatalyst and a highly fluorinated ion-exchange polymer binder, and the cathode electrocatalyst is comprised of platinum and cobalt supported on particulate carbon. The invention is also directed to a process for operating such a membrane electrode assembly in an organic/air fuel cell.

The present invention relates to membrane electrode assemblies, the manufacture of such assemblies, and the use of such assemblies in organic/air fuel cells such a direct methanol fuel cells.

### BACKGROUND

Electrochemical cells generally include an anode electrode and a cathode electrode separated by an electrolyte. A well-known use of electrochemical cells is in a stack for a fuel cell (a cell that converts fuel and oxidants to electrical energy) that uses a proton exchange membrane (PEM) as the electrolyte. In such a fuel cell, a reactant or reducing gas such as hydrogen or methanol is supplied to the anode electrode, and an oxidant such as oxygen or air is supplied to the cathode electrode. The reducing gas electrochemically reacts at a surface of the anode electrode to produce hydrogen ions and electrons. The electrons are conducted to an external load circuit and then returned to the cathode electrode, while hydrogen ions transfer through the electrolyte to the cathode electrode, where they react with the oxidant and electrons to produce water and release thermal energy.

Fuel cells are typically formed as stacks or assemblages of membrane electrode assemblies (MEAs), which each include a PEM, an anode electrode and cathode electrode, and other optional components. The fuel cells typically also comprise a porous electrically conductive sheet material that is in electrical contact with each of the electrodes and permits diffusion of the reactants to the electrodes, and is known as a gas diffusion layer, gas diffusion substrate or gas diffusion backing. When the electrocatalyst is coated on the PEM, the MEA is said to include a catalyst coated membrane (CCM). In other instances, where the electrocatalyst is coated on the gas diffusion layer, the MEA is said to include gas diffusion electrode(s) (GDE).

The most efficient fuel cells use pure hydrogen as the fuel and oxygen as the oxidant. However, the use of pure hydrogen has known disadvantages, including relatively high cost and storage considerations. Consequently, attempts have been made to operate fuel cells using fuels other than pure hydrogen. In an organic/air fuel cell, an organic fuel such as methanol, ethanol, formaldehyde, or formic acid is oxidized to carbon dioxide at an anode, while air or oxygen is reduced to water at a cathode. Fuel cells employing organic fuels are attractive for both stationary and portable applications, in part, because of the high specific energy of the organic fuels. One such organic/air fuel cell is a “direct oxidation” fuel cell in which the organic fuel is directly fed into the anode, where the fuel is oxidized. A direct methanol fuel cell is one such fuel cell system.

Materials customarily used as electrocatalysts are metals or simple alloys (e.g., Pt, Pt/Ru, Pt—Ir). For example, the state-of-the-art anode catalysts for organic/air fuel cells (e.g., direct methanol) may be based on platinum-ruthenium alloys. In hydrogen fuel cells, metal catalysts have been supported on high surface area conductive materials such as carbon to reduce the amount of catalyst required. For direct methanol fuel cell applications, where relatively large amounts of metal are typically needed for both the anode and cathode due to sluggish methanol oxidation kinetics and methanol crossover to the cathode, supported catalysts have conventionally not been used due to the large amount of precious metal required. The use of a supported catalyst on the anode or cathode of a hydrogen or direct methanol cell in which the catalyst has a high metal to support ratio is disclosed in PCT publication WO2005/001978. However, because the metal catalyst is the most expensive component of fuel cell MEAs for organic/air fuel cells, it is essential to somehow further reduce the amount of catalyst metal used in MEAs without sacrificing performance in order to make such fuel cells more economical.

### BRIEF DESCRIPTION OF THE DRAWING

FIG. 1 shows the voltage drop vs. time plot for the direct methanol MEAs described in Comparative Example F and in Example 3.

### DETAILED DESCRIPTION

The present invention provides a membrane electrode assembly for an organic/air fuel cell comprising a proton exchange membrane, an anode electrode, and a cathode electrode. The proton exchange membrane is made of a highly fluorinated ion-exchange polymer, and it has opposite first and second sides.

The anode electrode is adjacent to the first side of the membrane, and is comprised of 50 to 90 wt % of an anode electrocatalyst and 10 to 50 wt % of a highly fluorinated ion-exchange polymer binder. The anode electrocatalyst is comprised of an anode metal supported on carbon, where the anode metal is comprised of platinum and ruthenium and the carbon is particulate carbon. The anode electrocatalyst is comprised of at least 30 wt % platinum, at least 15 wt % ruthenium, and 15 to 50 wt % particulate carbon.

The cathode electrode is adjacent the second side of the membrane, and is comprised of 50 to 90 wt % of a cathode electrocatalyst and 10 to 50 wt % of a highly fluorinated ion-exchange polymer binder. The cathode electrocatalyst is comprised of a cathode metal supported on carbon, where the cathode metal is comprised of platinum and cobalt, and the carbon is particulate carbon. The cathode electrocatalyst is comprised of at least 30 wt % platinum, at least 1 wt % cobalt, and 15 to 60 wt % particulate carbon.

In a preferred embodiment, the metal loading in the anode electrode is less than 3 mg/cm² and the metal loading in the cathode electrode is less than 2 mg/cm².

The invention further provides organic/air fuel cells comprised of the membrane electrode assemblies of the invention.

The invention is also directed to a process for operating a membrane electrode assembly of an organic/air fuel cell. In the process, a proton exchange membrane made of a highly fluorinated ion-exchange polymer is provided. An anode electrode, as described above, is formed on one side of the membrane and a cathode electrode, as described above, is formed on the opposite side of the membrane. An electric circuit is formed between the anode and cathode electrodes, and an organic fuel is fed to the anode electrode and oxygen is fed to the cathode electrode so as to generate an electric current in the electric circuit. The organic fuel is preferably selected from the group of methanol, ethanol, formaldehyde, formic acid, and combinations, and is more preferably liquid methanol.

### Proton Exchange Membrane

The proton exchange membrane for use in organic/air fuel cell MEAs according to the invention are comprised of ion-exchange polymers. Ion-exchange polymers suitable for use in making PEMs of the MEAs according to the present invention include those polymers known for use in various types of fuel cells including, for example, highly fluorinated ion-exchange polymers. “Highly fluorinated” means that at least 90% of the total number of univalent atoms in the polymer are fluorine atoms. Most typically, the polymer is perfluorinated. It is typical for polymers used in fuel cell membranes to have sulfonate ion exchange groups. The term “sulfonate ion exchange groups” as used herein means either sulfonic acid groups or salts of sulfonic acid groups, typically alkali metal or ammonium salts.

The ion-exchange polymer employed comprises a polymer backbone with recurring side chains attached to the backbone with the side chains carrying the ion-exchange groups. Homopolymers or copolymers or blends thereof can be used. Copolymers are typically formed from one monomer that is a nonfunctional monomer and that provides atoms for the polymer backbone, and a second monomer that provides atoms for the polymer backbone and also contributes a side chain carrying a cation exchange group or its precursor, e.g., a sulfonyl halide group such a sulfonyl fluoride (—SO₂F), which can be subsequently hydrolyzed to a sulfonate ion exchange group. For example, copolymers of a first fluorinated vinyl monomer together with a second fluorinated vinyl monomer having a sulfonyl fluoride group (—SO₂F) can be used. The sulfonic acid form of the polymer may be utilized to avoid post treatment acid exchange steps. Exemplary first fluorinated vinyl monomers include tetrafluoroethylene (TFE), hexafluoropropylene, vinyl fluoride, vinylidine fluoride, trifluoroethylene, chlorotrifluoroethylene, perfluoro (alkyl vinyl ether), and mixtures of two or more thereof. Exemplary second monomers include fluorinated vinyl ethers with sulfonate ion exchange groups or precursor groups that can provide the desired side chain in the polymer. The first monomer can also have a side chain that does not interfere with the ion exchange function of the sulfonate ion exchange group. Additional monomers can also be incorporated into the polymers if desired.

Typical polymers for use in the PEMs include polymers having a highly fluorinated, most typically a perfluorinated, carbon backbone with a side chain represented by the formula —(O—CF₂CFRf)ₐ-(O—CF₂)_{c}—(CFR′f)_{b}SO₃M, where Rf and R′f are independently selected from F, Cl or a perfluorinated alkyl group having 1 to 10 carbon atoms, a=0, 1 or 2, b=0 to 6, and c=0-1, and M is hydrogen, Li, Na, K or N(R₁)(R₂)(R₃)(R₄) and R₁, R₂, R₃, and R₄ are the same or different and are H, CH₃ or C₂H₅. Specific examples of suitable polymers include those disclosed in U.S. Pat. Nos. 3,282,875; 4,358,545; and 4,940,525. One exemplary polymer comprises a perfluorocarbon backbone and a side chain represented by the formula —O—CF₂CF(CF₃)—O—CF₂CF₂SO₃H. Such polymers are disclosed in U.S. Pat. No. 3,282,875 and can be made by copolymerization of tetrafluoroethylene (TFE) and the perfluorinated vinyl ether CF₂═CF—O—CF₂CF(CF₃)—O—CF₂CF₂SO₂F, perfluoro(3,6-dioxa-4-methyl-7-octenesulfonyl fluoride) (PDMOF), followed by conversion to sulfonate groups by hydrolysis of the sulfonyl fluoride groups and ion exchanging to convert to the acid form, also known as the proton form. Another ion-exchange polymer of the type disclosed in U.S. Pat. Nos. 4,358,545 and 4,940,525 has a side chain —O—CF₂CF₂SO₃H. The polymer can be made by copolymerization of tetrafluoroethylene (TFE) and the perfluorinated vinyl ether CF₂═CF—O—CF₂CF₂SO₂F, perfluoro(3-oxa-4-pentenesulfonyl fluoride) (POPF), followed by hydrolysis and acid exchange. Suitable perfluorinated polymer ion-exchange membranes in sulfonic acid form are available under the trademark Nafion® from E.I. du Pont de Nemours and Company, Wilmington, Del.

For perfluorinated polymers of the type described hereinabove, the ion-exchange capacity of a polymer can be expressed in terms of ion-exchange ratio (“IXR”). Ion-exchange ratio is the number of carbon atoms in the polymer backbone in relation to the ion-exchange groups. A wide range of IXR values for the polymer are possible. Typically, however, the IXR range for perfluorinated sulfonate polymers is from about 7 to about 33. For perfluorinated polymers of the type described hereinabove, the cation exchange capacity of a polymer can be expressed in terms of equivalent weight (EW). Equivalent weight (EW), as used herein, is the weight of the polymer in acid form required to neutralize one equivalent of NaOH. For a sulfonate polymer having a perfluorocarbon backbone and a side chain —O—CF₂—CF(CF₃)—O—CF₂—CF₂—SO₃H (or a salt thereof), the equivalent weight range corresponding to an IXR of about 7 to about 33 is about 700 EW to about 2000 EW. A preferred range for IXR for such a polymer is from about 8 to about 23 (750 to 1500 EW), and a more preferred range is from about 9 to about 15 (800 to 1100 EW).

The membranes can be made by known extrusion or casting techniques and may have thicknesses that can vary depending upon the intended application. The membranes typically have a thickness of 350 μm or less, with some membranes employed in certain MEAs for organic/air fuel cell applications having a thickness of 50 μm or less.

Reinforced perfluorinated ion exchange polymer membranes can also be utilized in the MEA according to the invention. Reinforced membranes can be made by impregnating a porous substrate with ion-exchange polymer. The porous substrate may improve mechanical properties for some applications and/or decrease costs. The porous substrate can be made from a wide range of materials, such as but not limited to non-woven or woven fabrics, using various weaves such as the plain weave, basket weave, leno weave, or others. The porous support may be made from glass, hydrocarbon polymers such as polyolefins, (e.g., polyethylene, polypropylene, polybutylene, and copolymers), and perhalogenated polymers such as polychlorotrifluoroethylene. Porous inorganic or ceramic materials may also be used. For resistance to thermal and chemical degradation, the support typically is made from a fluoropolymer, more typically a perfluoropolymer. For example, the perfluoropolymer of the porous support can be a microporous film of polytetrafluoroethylene (PTFE) or a copolymer of tetrafluoroethylene. Microporous PTFE films and sheeting are known that are suitable for use as a support layer. For example, U.S. Pat. No. 3,664,915 discloses uniaxially stretched film having at least 40% voids. U.S. Pat. Nos. 3,953,566, 3,962,153 and 4,187,390 disclose porous PTFE films having at least 70% voids. Impregnation of expanded PTFE (ePTFE) with perfluorinated sulfonic acid polymer is disclosed in U.S. Pat. Nos. 5,547,551 and 6,110,333. ePTFE is available under the trade name “Goretex” from W. L. Gore and Associates, Inc., Elkton, Md., and under the trade name “Tetratex” from Tetratec, Feasterville, Pa.

### Electrocatalysts

The MEA of the invention includes an anode electrode comprised of 50 to 90 wt % of a platinum and ruthenium containing electrocatalyst and 10 to 50 wt % of a highly fluorinated ion-exchange polymer binder, and a cathode electrode comprised of 50 to 90 wt % of a platinum and cobalt containing electrocatalyst and 10 to 50 wt % of a highly fluorinated ion-exchange polymer binder. The anode electrode electrocatalyst is comprised of at least 30 wt % platinum, at least 15 wt % ruthenium, and 15 to 50 wt % particulate carbon wherein the platinum and ruthenium are supported on the particulate carbon. The cathode electrode electrocatalyst is comprised of at least 30 wt % platinum, at least 1 wt % cobalt, and 15 to 60 wt % particulate carbon wherein the platinum is supported on the particulate carbon.

Preferred particulate carbon support materials (prior to any optional chemical treatment) are turbostratic or graphitic carbons of varying surface areas. The carbon is preferably a medium to high surface area powder having a surface area of 100 to 2000 m²/g. Examples of such particulate carbons include Cabot Corporation's Vulcan® XC72R, Akzo Noble Ketjen® 600 or 300, Vulcan® Black Pearls (Cabot Corporation), acetylene black (Denki Kagku Kogyo Kabushiki Kaisha), as well as other carbon particle varieties. Other particulate carbons include acetylene black and other graphite powders, single or multiwalled carbon nanotubes, short fibers and other carbon structures (e.g., fullerenes, nanohorns).

The electrocatalysts can be made according to those methods known to those skilled in the art. For example, the supported catalysts can be made by a colloidal oxide method (Watanabe et al., J. Electroanal. Chem., 229-395, 1987) in which platinum sulfite acid and other oxidizable precursors (e.g., RuCl₃) are reacted with hydrogen peroxide to create the colloidal oxide particles to create deposited electrocatalysts. Other known methods, such as impregnation followed by chemical reduction or reduction with gas phase hydrogen, can also be used.

Suitable metals for use in the anode electrocatalyst include platinum and ruthenium, and may optionally include additional metals such as palladium, silver, chromium, cobalt, tungsten, rhodium, iridium, rhenium and molybdenum and combinations (or alloys) thereof. The preferred metals for the anode electrocatalyst are platinum/ruthenium alloys or other compositions containing platinum and ruthenium. The anode metals may be elemental metals, metal alloys, metal oxides, and hydrated metal oxides or combinations thereof. The metals can be used in either a zero valence state or a non-zero valence state. The metal compositions are described herein by reference to the weight percentage of the metal components as a percentage of the total electrocatalyst weight (including the particulate carbon support). The metals weight percent is based solely on the weight of the elemental metals, metal alloys and the metal components of metal oxides or hydrated metal oxides, and does not include the weight of the carbon support or other non-metal components. The anode electrocatalyst of the invention is preferably comprised of about 30 to about 80 weight percent platinum and about 15 to about 60 weight percent ruthenium, and the atomic ratio of Pt:Ru is preferably in the range from 1:1 to 4:1. More preferably, the anode electrocatalyst is comprised of about 30 to about 60 weight percent platinum, about 20 to about 40 weight percent ruthenium, and about 20 to about 50 weight percent particulate carbon. Most preferably, the anode electrocatalyst is comprised of about 40 to about 50 weight percent platinum, about 25 to about 35 weight percent ruthenium, and about 25 to about 40 weight percent particulate carbon.

Suitable metals for use in the cathode electrocatalyst are platinum and cobalt, and may optionally include additional metals such as palladium, silver, ruthenium, chromium, tungsten, rhodium, iridium, rhenium and molybdenum and combinations (or alloys) thereof. The cathode metals may be elemental metals, metal alloys, metal oxides, and hydrated metal oxides or combinations thereof. The metals can be used in either a zero valence state or a non-zero valence state. The metal compositions are described herein by reference to the weight percentage of the metal element as a percentage of the total electrocatalyst weight (including the particulate carbon support). The metals weight percent is based solely on the weight of the elemental metals, metal alloys and the metal components of metal oxides or hydrated metal oxides, and does not include the weight of the carbon support or other non-metal components. The cathode electrocatalyst of the invention is preferably comprised of about 30 to about 80 weight percent platinum, about 1 to about 15 weight percent cobalt, and about 15 to about 60 weight percent particulate carbon. More preferably, the cathode electrocatalyst is comprised of about 30 to 60 weight percent platinum, about 2 to 10 weight percent cobalt, and about 25 to 60 weight percent particulate carbon.

In a process to produce the anode or cathode electrocatalyst, an aqueous platinum mixture may be utilized. The aqueous platinum mixture contains a soluble platinum precursor that either is in a lower valence state (below Pt 4+) or can be reduced to a lower valence state. The platinum in the aqueous platinum mixture is preferably provided in its +2 oxidation state for use in making the catalyst. For example, chloroplatinic acid, H₂PtCl₆ can be reduced with NaHSO₃ to form H₃Pt(O₃)₂OH, platinum sulfite acid, a Pt(II) reagent, in situ. Chloroplatinic acid contains Pt in a +4 oxidation state, i.e., Pt(IV). Alternatively, H₃Pt(SO₃)₂OH, or other soluble platinum +2 (Pt(II)) salts such as ammonium tetrachloroplatinate (II), potassium tetrachloroplatinate (II), water soluble platinum (II) phosphine complexes (e.g. chlorotris(2,3,5-triaza-7-phosphoadamantane)platinum (II) chloride, (TPA)₃PtCl₂) or other lower valent water soluble platinum salts, can be used directly. However, the use of chloroplatinic acid, followed by reaction with NaHSO₃, or of H₃Pt(SO₃)₂OH directly is preferred. When electrocatalysts containing platinum are prepared using chloroplatinic acid, the concentration of the chloroplatinic acid solution is not critical. However, the concentration of chloroplatinic acid can generally vary between about 1 and about 20 weight percent platinum, with about 5 to about 15 weight percent platinum being advantageously used.

The anode electrocatalyst comprising platinum and ruthenium can be prepared using a reagent solution also containing ruthenium, such as ruthenium chloride solution, which is combined with an aqueous platinum mixture as described above, in the presence of an oxidant, to form an electrocatalyst mixture. Ruthenium chloride solutions can be prepared by methods known to those skilled in the art. Although the concentration of ruthenium chloride in the solution is not critical, from about 1 weight percent to about 10 weight percent can be advantageously used, and about 2 weight percent is preferred. The ruthenium chloride solution is preferably added to the aqueous platinum mixture described above. Also preferably, when used with a particulate carbon support, the ruthenium chloride solution is added at a rate greater than 0.3 mmoles Ru/minute, preferably from about 0.7 to about 4.0 mmoles ruthenium/minute, more preferably, from about 0.9 to about 3.6 mmoles Ru/minute. Other soluble ruthenium precursors can also be used, such as ruthenium (III) nitrosylnitrate, ruthenium (III) nitrosylsulfate, and other water soluble ruthenium reagents with a ruthenium valence less than (IV). Ruthenium chloride is preferred.

Following the formation of the electrocatalyst mixture, an oxidizer, such as hydrogen peroxide, is added to the electrocatalyst mixture. Other suitable oxidizing agents include water soluble agents (e.g., hypochlorous acid) or gas phase oxidizing agents such as ozone. Gas phase oxidizing agents can be introduced by bubbling into the liquid media. The oxidizing agent is added to convert the Pt(II) reagent to colloidal PtO₂, in which platinum is Pt(IV). The introduction of the oxidizing agent forms a colloid mixture, in which the platinum is present in colloidal form. When ruthenium chloride is present in the electrocatalyst mixture, and excess oxidizing agent (e.g., excess hydrogen peroxide) is present, the oxidizing agent can react with the ruthenium chloride to form ruthenium oxide, which is also present as a colloid. The amount of hydrogen peroxide used in the reaction can be from about 15:1 to 700:1, based on the mole ratio of H₂O₂ to total moles of metal, preferably 100:1 to 300:1 and more preferably about 210:1. When a platinum and ruthenium electrocatalyst mixture is being generated, instead of adding all of the hydrogen peroxide after the addition of the platinum solution, a portion of the hydrogen peroxide can be added simultaneously with the ruthenium chloride.

A surfactant or dispersant can be added to the chloroplatinic acid solution, following the addition of NaHSO₃ to generate H₃Pt(SO₃)₂OH). Alternatively, if the Pt(II) reagent is incorporated directly rather than generated in situ, a surfactant or dispersant can be added directly thereto. When making the platinum/ruthenium anode electrocatalyst, a surfactant or dispersant can also be directly added after the addition of the ruthenium chloride, which may be desirable when foaming or reaction of the surfactant with hydrogen peroxide is likely. As yet another alternative, the surfactant or dispersant can be added to the carbon, which is then added to the colloid mixture. In one preferred embodiment, the surfactant is added to the colloid mixture following the RuCl₃ addition, optionally dispersing the carbon support and adding the surfactant carbon support slurry to the reaction mixture.

Surfactants and dispersants known to those skilled in the art are disclosed in PCT application WO 2004/073090, which is hereby incorporated by reference. As used herein, “dispersants” refers to a class of materials that are capable of bringing fine solid particles into a state of suspension so as to inhibit or prevent their agglomeration or settling in a fluid medium. The term “surfactant” (or surface active agent) as used herein refers to substances with certain characteristic features in structure and properties, such as amphipathic structure (having groups with opposing solubility tendencies); solubility in liquid media; formation of micelles at certain concentrations; formation of orientated monolayers at phase interfaces—surfactant molecules and ions form oriented monolayers at phase interfaces (in this case, liquid-solid interface); and adsorption at interfaces. Thus, although a surfactant can operate to disperse particles, a dispersant need not have the properties of a surfactant and can operate by different mechanisms than would a surfactant. Accordingly, the terms are not used interchangeably herein. Surfactants and dispersants suitable for use in the processes for making the electrocatalysts can be anionic surfactants containing carboxylate, sulfonate, sulfate or phosphate groups; and nonionic surfactants such as those derived from ethoxylates, carboxylic acid esters, carboxylic amines, and polyalkylene oxide block copolymers.

The surfactant or dispersant is preferably provided in the form of a suspension. The suspension contains sufficient surfactant or dispersant to stabilize the colloid and the particulate carbon. Preferably, the suspension contains from about 0.0001 weight percent to about 20 weight percent of surfactant or dispersant based on the total combined weight of solids. Total combined weight of solids means the total weight of surfactant/dispersant, metal, and particulate carbon. More preferably, the suspension contains from about 0 weight percent to about 10 weight percent of surfactant or dispersant, even more preferably from about 0.01 to about 5 weight percent surfactant or dispersant, and still more preferably from about 1 to about 2 weight percent surfactant or dispersant, based on the total combined weight of solids. The concentration of surfactant or dispersant in the suspension is not critical. However, it has been found that a surfactant or dispersant concentration of about 10 weight percent can be advantageously used.

Sodium hydrogen sulfite, NaHSO₃, which converts platinum (IV) chloride to a platinum (II) hydrogen sulfite, can also be present in the suspension and can be provided in this manner for the conversion of the platinum to the +2 oxidation state. The concentration of NaHSO₃ can vary, and, expressed in terms of the mole ratio of NaHSO₃ to platinum, is preferably from about 3:1 to about 20:1, more preferably from about 5:1 to about 15:1, and even more preferably from about 7:1 to about 12:1.

After the platinum and ruthenium reagents have been generated to form an anode electrocatalyst mixture, and following addition of hydrogen peroxide, chemically treated particulate carbon, such as acidified particulate carbon, is added to the catalyst mixture. The carbon can be provided, for example, as a slurry or in solid form. Chemically treating the carbon can be accomplished by methods know to those skilled in the art. Acidification can be carried using various oxidizing acids. For example, carbon particles can be treated with an oxidizing agent such as oxygen gas, hydrogen peroxide, organic peroxides, ozone, or they can be oxidized and acidified with oxidizing acids such as, for example, nitric acid, perchloric acid, chloric acid, permanganic acid, or chromic acid. In some embodiments, a slurry of particulate carbon can be made with a dilute acid solution, and acidification can be effected by heating, for example, by refluxing the slurry. Optionally, in particular when the particles are treated with a functionalizing agent such as oxygen gas, ozone or a volatile organic peroxide, the particles can be heated, for example, to a temperature of about 175° C., preferably no higher than about 100° C. to avoid decomposition of the carbon.

After the carbon has been added to the catalyst mixture, the catalyst mixture and carbon are contacted with a precipitating agent, which, it is believed, partially reduces the catalyst mixture and helps precipitate or deposit the catalyst particles on the support. Hydrogen gas is a preferred precipitating agent. Optionally, the contacting with the reducing agent can be done in a controlled environment, such as, for example, in the presence of nitrogen. The use of an inert atmosphere such as a nitrogen atmosphere may be desirable when hydrogen gas is used as the precipitating agent.

The platinum-cobalt electrocatalyst for the cathode electrode can be made by sequential or simultaneous deposition of the platinum and cobalt on the particulate carbon support. Sequential deposition is preferred. The platinum catalyst can be prepared according to the process described above. The deposition of cobalt can be accomplished by adding a metal salt that is subsequently reduced at elevated temperature, which facilitates alloy formation.

Controlling the rate of addition of certain components used in making the electrocatalysts to other components improves the quality of the electrocatalysts produced according to the processes disclosed herein. In addition, functionalization of the particulate carbon support used in the processes, when combined with control of the rate of addition of components to each other and/or the use of a surfactant or dispersant, provides improved properties of the electrocatalyst produced including minimization or elimination of metal particle agglomeration on the carbon support.

In a preferred embodiment of the invention, the anode electrocatalyst is in the form of anode electrocatalyst particles and the cathode electrocatalyst is in the form of cathode electrocatalyst particles. These particles may be made up of aggregates of smaller primary particles. When these electrocatalyst particles are incorporated into an electrode, it is preferred that at least 98% of the anode and cathode electrocatalyst particles have a particle diameter of less than 10 microns. Particles size may be measured using laser light scattering measurement techniques. The size of the particles in a liquid catalyst ink is measured using a Hegman guage.

### Electrodes

The MEA of the invention includes an anode electrode facing one side of the PEM and a cathode electrode facing the opposite side of the PEM. The anode and cathode electrodes may be contacted, adhered directly to, or coated on the PEM so as to form a CCM, which is sometimes referred to as an MEA3. Alternatively, one or both of the electrodes may be coated on or adhered to the PEM-facing side of gas diffusion layers positioned on opposite sides of the PEM.

According to the invention, the anode electrode adjacent a first side of the PEM is comprised of 50 to 90 wt % of an anode electrocatalyst and 10 to 50 wt % of a highly fluorinated ion-exchange polymer binder. The anode electrocatalyst is comprised of at least 30 wt % platinum, at least 15 wt % ruthenium, and 15 to 50 wt % particulate carbon wherein the platinum catalyst and ruthenium catalyst are supported on the particulate carbon.

According to the invention, the cathode electrode adjacent the opposite second side of the PEM from the anode is comprised of 50 to 90 wt % of an electrocatalyst and 10 to 50 wt % of a highly fluorinated ion-exchanged polymer binder. The cathode electrocatalyst is comprised of at least 30 wt % platinum, at least 1 wt % cobalt, and 15 to 60 wt % particulate carbon wherein the platinum is supported on the particulate carbon.

In the anode electrode, it is preferable to adjust the amounts of anode electrocatalyst, ion-exchange polymer and other components, if present, so that the anode electrocatalyst is a major component by weight of the resulting electrode. More preferably, the weight ratio of anode electrocatalyst to ion-exchange polymer binder in the anode electrode is about 1:1 to about 10:1, and more preferably 2:1 to 5:1.

In the cathode electrode, it is preferable to adjust the amounts of cathode electrocatalyst, ion-exchange polymer and other components, if present, so that the cathode electrocatalyst is a major component by weight of the resulting electrode. More preferably, the weight ratio of cathode electrocatalyst to ion-exchange polymer binder in the cathode electrode is about 6:1 to about 1:1, and more preferably 4:1 to 1:1.

For the electrodes to function effectively in the fuel cells, effective anode and cathode electrocatalyst sites must be provided in the anode and cathode electrodes. In order for the anode and cathode to be effective: (1) the electrocatalyst sites must be accessible to the reactant, (2) the electrocatalyst sites must be electrically connected to the gas diffusion layer, and (3) the electrocatalyst sites must be ionically connected to the fuel cell electrolyte. It is believed that the incorporation of a porous particulate carbon support in the anode and cathode electrocatalysts helps to make the electrocatalyst sites more accessible to the reactants while also electrically connecting the electrocatalyst sites to the diffusion layer of the MEA. The electrocatalyst sites are ionically connected to the electrolyte via the ion-exchange polymer binder of the electrode.

Because the binder employed in the electrode serves not only as binder for the electrocatalyst particles, but may also assist in securing the electrode to the membrane, it is preferred that the ion-exchange polymers in the binder composition be compatible with the ion-exchange polymer in the membrane. Most typically, ion-exchange polymers in the binder composition are the same type as the ion exchange polymer in the PEM. Where the electrodes are coated on or otherwise adhered to the membrane, the binder used in the electrodes is preferably the same ion exchange polymers that comprise the membranes. Ion-exchange polymers suitable for the binder of the anode and cathode electrodes of the MEAs of the invention are the highly fluorinated ion-exchange polymers discussed above for use in making the proton exchange membranes. The ion-exchange polymers typically have end groups in sulfonyl halide form, but may alternatively have end groups in the sulfonic acid form.

According to one preferred embodiment of the invention, the cathode electrode, the anode electrode or both the cathode and anode electrode may further include a hydrophobic fluoropolymer. When an electrocatalyst of platinum/cobalt supported on carbon is used in the cathode electrode, it has been found that the addition of a hydrophobic fluoropolymer can be beneficial because the carbon supported platinum/cobalt catalyst is more hydrophilic than a carbon supported platinum. This hydrophobic fluoropolymer may, for example, be PTFE, but it is more preferably an amorphous fluoropolymer such a copolymer of tetrafluoroethylene and a comonomer from the group of hexafluoropropylene (HFP), perfluoroalkyl vinyl ether, 2,2-bistrifluoromethyl 4,5-difluoro-1,3-dioxole (PDD). Suitable amorphous fluoropolymers are disclosed in U.S. Pat. No. 6,880,238, which is hereby incorporated by reference. A preferred amorphous fluoropolymer is a copolymer of tetrafluoroethylene and PDD, most preferably of 67 mol-% (available as Teflon® AF1600 from DuPont, Wilmington, Del.). A preferred amount of hydrophobic fluoropolymer is 1.5 to 15 percent of the weight of the electrocatalyst. Where a hydrophobic fluoropolymer is added to the cathode electrode, the fluoropolymer can be distributed throughout the ion-exchange polymer binder. When the ion-exchange polymer binder used to make the electrode is in the acid form, then a dispersion of PTFE in water or other suitable solvent may be used. In order to incorporate the hydrophobic fluoropolymer into an electrode, the fluoropolymer is typically added to the catalyst ink slurry directly as a fluoropolymer dispersion or solution in a fluorinated solvent.

In order to form the anode or cathode electrodes, the anode electrocatalyst or the cathode electrocatalyst, as described above is slurried with a dispersion of a highly fluorinated ion-exchange polymer, preferably a perfluorinated ionomer in an appropriate solvent to form a catalyst dispersion. The slurry may further include hydrophobic fluoropolymer as discussed above, or any additional additives such as are commonly employed in the art may also be incorporated into the slurry.

Preferred ionomers are those described above for use in the proton exchange membrane, such as perfluorinated copolymers of PTFE and a monomer having pendant groups described by the formula

—(O—CF₂CFR_{f})ₐ—O—CF₂(CFR′_{f})_{b}SO₂F,

where R_{f} and R′_{f}′ are independently selected from F, Cl or a perfluorinated alkyl group having 1 to 10 carbon atoms, a=0, 1 or 2, and b=0 to 6. Preferably, R is trifluoromethyl, R′ is F, a=0 or 1 and b=1. Most preferably, R_{f} is trifluoromethyl, R′_{f}′ is F, a=1 and b=1. Alternatively, the ion-exchange polymer can be a copolymer of PTFE and a monomer having pendant groups described by the formula

—(O—CF₂CFR_{f})ₐ—O—CF₂(CFR′_{f})_{b}SO₃-M⁺,

where R_{f} and R′_{f}′ are independently selected from F, Cl or a perfluorinated alkyl group having 1 to 10 carbon atoms, a=0, 1 or 2, b=0 to 6, and M is H or a univalent metal. Preferably, R_{f} is trifluoromethyl, R′_{f}′ is F, a=0 or 1, b=1, and M is H or an alkali metal, and most preferably, a=1 and M is H. When M is an alkali metal such that the sulfonyl halide form of the polymer is used (e.g., —SO₂F), an additional ion exchange step must be introduced at some convenient stage in the process herein outlined to convert the electrode to the acid form (i.e., convert the M to H).

Anode and cathode electrodes for the MEAs of the invention can be produced using an ion-exchange polymer binder in the acid form in the ink. The anode or cathode electrocatalyst may be combined with the acid form of the ionomer, and electrochemically active electrodes can fabricated directly from the combination without additional treatment steps. Alternatively, the cathode and anode electrodes can be formed from a slurry in which the perfluorinated ionomer is in sulfonyl fluoride form and later converted to the acid form after the electrodes have been formed. Contacting the sulfonyl fluoride form of the ionomer with a mineral acid in any convenient manner will suffice to convert it to the acid form required for it to conduct protons. Suitable ion-exchange polymers have equivalent weights in the range of 700-2000EW.

An electrocatalyst ink or paste for use in making the anode or cathode electrode is made by combining the electrocatalyst, the highly fluorinated ion-exchange polymer, and a suitable liquid medium. It is advantageous for the medium to have a sufficiently low boiling point that rapid drying of electrode layers is possible under the process conditions employed, provided however, that the composition does not dry so fast that the composition dries before transfer to the membrane. When flammable constituents are to be employed, the medium can be selected to minimize process risks associated with such constituents, as the medium is in contact with the electrocatalyst during use. The medium should also be sufficiently stable in the presence of the ion-exchange polymer that, in the acid form, has strong acidic activity. The liquid medium is typically polar for compatibility with the ion-exchange polymer, and is preferably able to wet the proton exchange membrane. Preferably, the ion-exchange polymer coalesces upon drying of the liquid medium and the polymer does not require post treatment steps such as heating to form a stable electrode layer. Where the liquid medium is water, it may be used in combination with surfactant, alcohols or other miscible solvents.

A wide variety of polar organic liquids and mixtures thereof can serve as suitable liquid medium for the electrocatalyst coating ink or paste. Water can be present in the medium if it does not interfere with the coating process. Although some polar organic liquids can swell the membrane when present in sufficiently large quantity, the amount of liquid used in the electrocatalyst coating is preferably small enough that the adverse effects from swelling during the process are minor or undetectable. It is believed that solvents able to swell the ion-exchange membrane can provide better contact and more secure application of the electrode to the membrane. A variety of alcohols are well suited for use as the liquid medium.

Typical liquid mediums include suitable C₄ to C₈ alkyl alcohols such as n-, iso-, sec- and tert-butyl alcohols; the isomeric 5-carbon alcohols such as 1,2- and 3-pentanol, 2-methyl-1-butanol, 3-methyl, 1-butanol; the isomeric 6-carbon alcohols, such as 1-, 2-, and 3-hexanol, 2-methyl-1-pentanol, 3-methyl-1-pentanol, 2-methyl-1-pentanol, 3-methyl, 1-pentanol, 4-methyl-1-pentanol; the isomeric C₇ alcohols and the isomeric C₈ alcohols. Cyclic alcohols are also suitable. Preferred alcohols are n-butanol and n-hexanol, and n-hexanol is more preferred. Other preferred liquid mediums are fluorinated solvents such as the primarily 12 carbon perfluoro compounds of FC-40 and FC-70 Fluorinert™ brand electronic liquids from 3M Company. The amount of liquid medium used in the electrocatalyst coating ink or paste varies and is determined by the type of medium employed, the constituents of the electrocatalyst coating, the type of coating equipment employed, the desired electrode thickness, the process speeds, and other process conditions.

The size of the particles in the electrocatalyst ink is reduced by grinding, milling or sonication to obtain a particle size that results in the best utilization of the electrocatalyst. The particle size, as measured by a Hegman gauge, is preferably reduced to less than 10 microns and more preferably to less than 5 microns.

The resulting electrocatalyst paste or ink may then be coated onto an appropriate substrate for incorporation into an MEA. The method by which the coating is applied is not critical to the practice of the present invention. Known electrocatalyst coating techniques can be used and produce a wide variety of applied layers of essentially any thickness ranging from very thick, e.g., 30 μm or more, to very thin, e.g., 1 μm or less. Typical manufacturing techniques involve the application of the electrocatalyst ink or paste onto either the polymer exchange membrane or a gas diffusion substrate. Additionally, electrode decals can be fabricated and then transferred to the membrane or gas diffusion backing layers. Methods for applying the electrocatalyst onto the substrate include spraying, painting, patch coating and screen printing or flexographic printing. Preferably, the thickness of the anode and cathode electrodes ranges from about 0.1 to about 30 microns, more preferably less than 25 micron. The applied layer thickness is dependent upon compositional factors as well as the process used to generate the layer. The compositional factors include the metal loading on the coated substrate, the void fraction (porosity) of the layer, the amount of polymer/ionomer used, the density of the polymer/ionomer, and the density of the carbon support. The process used to generate the layer (e.g. a hot pressing process versus a painted on coating or drying conditions) can affect the porosity and thus the thickness of the layer.

In a preferred embodiment, a catalyst coated membrane is formed wherein thin electrode layers are attached directly to opposite side of the proton exchange membrane. In one method of preparation, the catalyst film is prepared as a decal by spreading the catalyst ink on a flat release substrate such as Kapton® polyimide film (available from the DuPont, Wilmington, Del.). The decal is transferred to the surface of the membrane by the application of pressure and optional heat, followed by removal of the release substrate to form a CCM with a catalyst layer having a controlled thickness and catalyst distribution. The membrane is preferably wet at the time that the electrode decal is transferred to the membrane. Alternatively, the electrocatalyst ink may be applied directly to the membrane, such as by printing, after which the catalyst film is dried at a temperature not greater than 200° C. The CCM, thus formed, is then combined with a gas diffusion backing substrate to form an MEA.

Another method is to first combine the catalyst ink of the invention with a gas diffusion backing substrate, and then, in a subsequent thermal consolidation step, with the proton exchange membrane. This consolidation may be performed simultaneously with consolidation of the MEA at a temperature no greater than 200° C., preferably in the range of 140-160° C. The gas diffusion backing comprises a porous, conductive sheet material such as paper or cloth, made from a woven or non-woven carbon fiber, that can optionally be treated to exhibit hydrophilic or hydrophobic behavior, and coated on one or both surfaces with a gas diffusion layer, typically comprising a film of particles and a binder, for example, fluoropolymers such as PTFE. Gas diffusion backings for use in accordance with the present invention as well as the methods for making the gas diffusion backings are those conventional gas diffusion backings and methods known to those skilled in the art. Suitable gas diffusion backings are commercially available, including for example, Zoltek® carbon cloth (available from Zoltek Companies, St. Louis, Mo.) and ELAT® (available from E-TEK Incorporated, Natick, Mass.).

### Membrane Electrode Assemblies for Fuel Cells

The present invention also contemplates the use of the membrane electrode assemblies in a fuel cell, wherein the assembly includes the proton exchange membrane, the anode and cathode electrodes, and the gas diffusion backings. Bipolar separator plates, made of a conductive material and providing flow fields for the reactants, are placed between adjacent MEAs. A number of MEAs and bipolar plates are assembled in this manner to provide a fuel cell stack.

It is desirable to seal reactant fluid stream passages in a fuel cell stack to prevent leaks or inter-mixing of the fuel and oxidant fluid streams. Fuel cell stacks typically employ fluid tight resilient seals, such as elastomeric gaskets between the separator plates and membranes. Such seals typically circumscribe the manifolds and the electrochemically active area. Sealing can be achieved by applying a compressive force to the resilient gasket seals. Compression enhances both sealing and electrical contact between the surfaces of the separator plates and the MEAs, and sealing between adjacent fuel cell stack components. In conventional fuel cell stacks, the fuel cell stacks are typically compressed and maintained in their assembled state between a pair of end plates by one or more metal tie rods or tension members. The tie rods typically extend through holes formed in the stack end plates, and have associated nuts or other fastening means to secure them in the stack assembly. The tie rods can be external, that is, not extending through the fuel cell plates and MEAs, however, external tie rods can add significantly to the stack weight and volume. It is generally preferable to use one or more internal tie rods that extend between the stack end plates through openings in the fuel cell plates and MEAs as described in U.S. Pat. No. 5,484,666. Typically resilient members are utilized to cooperate with the tie rods and end plates to urge the two end plates towards each other to compress the fuel cell stack.

The resilient members accommodate changes in stack length caused by, for example, thermal or pressure induced expansion and contraction, and/or deformation. That is, the resilient member expands to maintain a compressive load on the fuel cell assemblies if the thickness of the fuel cell assemblies shrinks. The resilient member may also compress to accommodate increases in the thickness of the fuel cell assemblies. Preferably, the resilient member is selected to provide a substantially uniform compressive force to the fuel cell assemblies, within anticipated expansion and contraction limits for an operating fuel cell. The resilient member can comprise mechanical springs, or a hydraulic or pneumatic piston, or spring plates, or pressure pads, or other resilient compressive devices or mechanisms. For example, one or more spring plates can be layered in the stack. The resilient member cooperates with the tension member to urge the end plates toward each other, thereby applying a compressive load to the fuel cell assemblies and a tensile load to the tension member.

Organic/air fuel cells made using the membrane electrode assemblies as disclosed herein show an unexpected level of performance at significantly lower catalyst metal loadings than conventional organic/air fuel cells. A current density of 70 mWcm² at a voltage of 400 mVolts is generally the minimum necessary for use in a direct methanol fuel cell. This level of performance is exceeded by MEAs according to the invention having anode and cathode metals loading per electrode of less than 3 mg metal/cm². By contrast, in conventional MEAs where both cathode and anode electrocatalysts are unsupported, metal loading per electrode of at least 4.5 mg metal/cm² is needed to achieve the necessary minimum current density. Even where the cathode or anode catalyst has been supported on a carbon support, it has not been possible to achieve minimum necessary current densities with metals loading of under 4.5 mg metal/cm² in either the anode or cathode electrodes. Surprisingly, with an MEA according to one embodiment of the present invention, satisfactory current density was obtained with a total cathode and anode metals loading of less than 4 mg metal/cm². Equally significant, MEAs according to the invention are considerably more durable than conventional MEAs. The MEAs according to the invention maintain their voltage performance significantly longer than conventional MEAs with metal loadings much higher than the MEAs according to the invention. Thus the MEA of the invention has the advantage that it lasts longer while also using significantly less of expensive catalyst metals.

### EXAMPLES

The following specific examples are intended to illustrate the practice of the invention and should not be considered to be limiting in any way.

The following electrodes were prepared for use in the comparative examples and the examples below.

Cathode-A: A cathode catalyst dispersion ink was prepared in an Eiger® bead mill, (manufactured by Eiger Machinery Inc., Greylake, Ill.), containing 70 ml 1.0-1.25 millimeter zirconia grinding media. 100 grams of platinum black (unsupported) catalyst powder (fuel cell grade catalyst obtained from Colonial Metals, Elkton Md.) and 317.5 grams of a 3.5 wt % Nafion® solution (DuPont, Wilmington, Del.) in FC-40 Fluorinert™ brand electronic liquid perfluorinated solvent (3M Company, Minneapolis, Minn.) (the polymer resin had a 830 EW measured by FTIR and was in the sulfonyl fluoride form) were mixed and charged into the mill and dispersed for about 2 hours. Material was withdrawn from the mill and particle size was measured. The ink was tested to ensure that the particle size was under 10 microns and the percent solids was about 22.5 wt %. The ink was concentrated in a rotovap to 13 wt % solids. A catalyst electrode decal was prepared by drawing down the catalyst ink to a dimension of 5 cm×5 cm (to give a total area of 25 cm²) on a 10 cm×10 cm piece of 3 mil thick Kapton® polyimide film (obtained from DuPont, Wilmington, Del.). A Pt loading of 4.5 mg Pt/cm² was achieved by knife drawdown coating with this ink. The dry coating thickness was about 0.5 mil.

Cathode-B: The electrocatalyst ink used to produce Cathode-A (solids content 13 wt %) was used to produce another catalyst electrode decal by drawing down the catalyst ink to a dimension of 5 cm×5 cm (to give a total area of 25 cm²) on a 10 cm×10 cm piece of 3 mil thick Kapton® polyimide film. A Pt metal loading of 5.4 mg/cm² was achieved by knife drawdown coating with this ink.

Cathode-C: The electrocatalyst ink used to produce Cathode-A (solids content 13 wt %) was used to produce another catalyst electrode decal by drawing down the catalyst ink to a dimension of 5 cm×5 cm (to give a total area of 25 cm²) on a 10 cm×10 cm piece of 3 mil thick Kapton® polyimide film. A Pt metal loading of 4.8 mg/cm² was achieved by knife drawdown coating with this ink. The dry coating thickness was about 0.5 mil.

Cathode-D: 380.8 grams of a 3.5 wt % Nafion® solution in FC-40 Fluorinert™ brand electronic liquid perfluorinated solvent (the polymer resin had a 830 EW measured by FTIR and was in the sulfonyl fluoride form) was placed in a 600 gram container. The container was cooled in an ice bath to bring down the solution temperature to ˜0° C. while stirring the solution at 350 rpm using a high speed mixer (BDC 2002 mixer made by Caframo) in a nitrogen atmosphere. After the solution temperature reached ˜0° C., 30 grams of carbon supported Pt catalyst (67 wt % Pt, 33 wt % particulate carbon) with a BET surface area of 215 m²/g (TEC10E70TPM catalyst obtained from Tanaka Kikinzoku Kogyo KK, Kanagawa, Japan) was added slowly to the Nafion® solution over a period of about 5-7 minutes while mixing continued. Stirring was continued for 45 minutes after the addition of all of the carbon supported Pt. The mixture was then “sonicated” using a Branson Sonifier 450 at 70% power to break-up the electrocatalyst particles for 3-5 minutes at a time or until the temperature reached about 70° C. When the dispersion temperature reached 70° C., the sonication was stopped and the dispersion was cooled to room temperature in the ice bath before “sonication” was resumed. Sonication was stopped when the maximum particle size in the ink dispersion was determined to be less than 5 microns. Particle size was measured using a Hegman gauge. This ink dispersion was concentrated using a “rotovap” at about 70° C. until the solids content of the ink was about 23 wt %. The maximum particle size in the ink was once again tested. If the maximum particle size was more than 5 micron, the ink was sonicated again using the sonication process described above until the maximum particle size was below 5 microns. The solid content and the viscosity of the ink were measured and they were 21.4 wt % and 26,510 centipoise respectively.

A catalyst electrode decal was prepared by drawing down the catalyst ink to a dimension of 5 cm×5 cm (to give a total area of 25 cm²) on a 10 cm×10 cm piece of 3 mil thick Kapton® polyimide film. A Pt metal loading of 2.2 mg/cm² was achieved by knife drawdown coating with this ink. The dry coating thickness was about 0.9 mil.

Cathode-E: The electrocatalyst ink used to produce Cathode-D (solids content 21.4 wt % and viscosity of 26,510 centipoise) was used to produce another catalyst electrode decal by drawing down the catalyst ink to a dimension of 5 cm×5 cm (to give a total area of 25 cm²) on a 10 cm×10 cm piece of 3 mil thick Kapton® polyimide film. A Pt metal loading of 1.0 mg/cm² was achieved by knife drawdown coating with this ink. The dry coating thickness was about 0.4 mil.

Anode-A: An anode catalyst dispersion ink was prepared in an Eiger® bead mill, containing 70 ml 1.0-1.25 millimeter zirconia grinding media. 40 grams of platinum/ruthenium (50/50 alloy) black (unsupported) catalyst powder (Hi-Spec 6000 obtained from Johnson Mathey, London, England), and 162.9 grams of 3.5 wt % Nafion® solution (DuPont, Wilmington, Del.) in FC-40 Fluorinert™ brand electronic liquid perfluorinated solvent (3M Company, Minneapolis, Minn.) (the polymer resin had a 830 EW measured by FTIR and was in the sulfonyl fluoride form) were mixed and charged into the mill and dispersed for about 2 hours. Material was withdrawn from the mill and particle size measured. The ink was tested to ensure that the particle size was under 10 microns and the % solids was about 13 wt %. A catalyst electrode decal was prepared by drawing down the catalyst ink to a dimension of 5 cm×5 cm (to give a total area of 25 cm²) on a 10 cm×10 cm piece of 3 mil thick Kapton® polyimide film. A Pt/Ru metal loading of 4.5 mg/cm² was achieved by knife drawdown coating with the ink. The dry coating thickness was about 0.5 mil.

Anode-B: The electrocatalyst ink used to produce Anode-A (solids content 13 wt %) was used to produce another catalyst electrode decal by drawing down the catalyst ink to a dimension of 5 cm×5 cm (to give a total area of 25 cm²) on a 10 cm×10 cm piece of 3 mil thick Kapton® polyimide film. A Pt/Ru loading of 4.3 mg/cm² was achieved by knife drawdown coating with this ink.

Anode-C: The electrocatalyst ink used to produce Anode-A (solids content 13 wt %) was used to produce another catalyst electrode decal by drawing down the catalyst ink to a dimension of 5 cm×5 cm (to give a total area of 25 cm²) on a 10 cm×10 cm piece of 3 mil thick Kapton® polyimide film. A Pt/Ru loading of 5.1 mg/cm² was achieved by knife drawdown coating with this ink. The dry coating thickness was about 0.6 mil.

Cathode-1: A 100 ml plastic jar was filled half way with ⅜ inch cylindrical zirconia milling media and weighed. The media was then removed and set aside. 114.29 g of the 3.5 wt % Nafion® solution in FC-40 Fluorinert™ brand electronic liquid perfluorinated solvent (the polymer resin had a 830 EW measured by FTIR and was in the sulfonyl fluoride form) was weighed into the 100 ml plastic jar. The jar was placed in an ice bath and allowed to cool for 10 minutes with high shear mixing. 8.51 g of a nominal 46.3% Platinum, 4.8% Cobalt, about 49% particulate carbon catalyst (TEC36E52 catalyst obtained from Tanaka Kikinzoku Kogyo KK, Kanagawa, Japan) was weighed out and then slowly added by spatula over the course of one minute to the stirred 3.5 wt % Nafion® ionomer solution. Once all of the catalyst had been added to the Nafion® ionomer solution, the mixture was allowed to stir for an additional five minutes. After the five minutes of stirring, the plastic jar containing the ink was removed from the ice bath. The pre-weighed zirconia milling media was added to the jar, and the jar was placed on a roll mill (US Stoneware). The setting on the control of the roll mill was set at 50, which allows for the proper cascade of media in the jar. The jar was allowed to roll on the mill for 65 hours. After rolling, the ink was checked for particle size with a Hegman gauge, and was found to have a maximum particle size of less than five microns. The solids content of the ink was 9.8 wt %.

Flexographic printing was used to prepare 25 cm² decals on Kapton® polyimide film. A printing plate made of rubber. Ink was applied to a raised image on the plate, which transferred the image to the Kapton® film. A Pt/Co metal loading of 0.63 mg/cm² was printed. The decal was dried at ambient temperature.

Cathode-2: A 100 ml plastic jar was filled half way with ⅜ inch cylindrical zirconia milling media and weighed. The media was then removed and set aside. 114.29 g of the 3.5 wt % Nafion® solution in FC-40 Fluorinert™ brand electronic liquid perfluorinated solvent (the polymer resin had a 850 EW measured by FTIR and was in the sulfonyl fluoride form) with 12.27 g of a 6 wt % Teflon® AF dispersion in FC-40 Fluorinert™ brand electronic liquid was weighed into the 100 ml plastic jar. The jar was placed in an ice bath and allowed to cool for 10 minutes with high shear mixing. 8.0 g of a nominal 46.3 wt % Platinum, 4.8 wt % Cobalt, 48.9 wt % particulate carbon catalyst (TEC36E52 catalyst obtained from Tanaka Kikinzoku Kogyo KK, Kanagawa, Japan) was weighed out and then slowly added by spatula over the course of 1 minute to the stirred 3.5 wt % Nafion ® ionomer solution. Once all of the catalyst had been added to the Nafion ® ionomer solution, the mixture was allowed to stir for an additional five minutes. After the five minutes of stirring, the stirring was stopped and the plastic jar containing the ink was removed from the ice bath. The pre-weighed zirconia milling media was added to the jar, and the jar was placed on a roll mill (US Stoneware). The setting on the control of the roll mill was set at 50 which allows for the proper cascade of media in the jar. The jar was allowed to roll on the mill for a total of 90 hours. After rolling, the ink was checked for particle size with a Hegman gauge, and was found to have a maximum particle size of less than five microns.

Flexographic printing was used to prepare 25 cm² decals on Kapton® polyimide film using a printing plate made of rubber. Ink was applied to a raised image on the plate, which transferred the image to the Kapton® film. A Pt/Co metal loading of 0.55 mg/cm² was printed. The decal was dried at ambient temperature.

Cathode-3: The electrocatalyst ink used to produce Cathode-1 was used to flexographically print another 25 cm² catalyst electrode decal on a piece of Kapton® polyimide film. A Pt/Co loading of the decal was 0.63 mg/cm² and the decal was dried at ambient temperature.

Cathode-4: 33.9 grams of a 10.6 wt % solids solution of Nafion® 920 EW dispersion (in the proton form) (DuPont DE2020, 21.3% solids) in diprolyleneglycolmonomethyl ether was added to a beaker which was immersed in an ice bath. The beaker was in a nitrogen purged box in a hood and the dispersion was chilled to about 10° C. while stirring the solution with high shear mixing. A mixture of 39.91 grams of diprolyleneglycolmonomethyl ether and 9.02 grams of DI water was added to the dispersion. After the dispersion temperature reached ˜10° C., 9.79 grams of an electrocatalyst comprised of 2:1 platinum/cobalt metal supported on particulate carbon (50% wt % metal, 50 wt % particulate carbon) (TEC36E52 obtained from Tanaka Kikinzoku Kogyo KK, Kanagawa, Japan) was slowly added to the dispersion over a period of about 15 minutes with high shear mixing continued and the dispersion was cooled to about 6° C. A rotovap was used for removal of alcohols. Mixing was stopped and the dispersion was allowed to warm up to ambient temperature. Upon warming to ambient temperature, the mixture was circulated through an Eiger® bead mill, (manufactured by Eiger Machinery Inc., Greylake, Ill.), containing 70 ml 1.0-1.25 millimeter zirconia grinding media for four minutes. The particle size in the dispersion was measured with a Coulter counter and indicated the D₅₀ to be 2.4 microns. 0.33 grams of PTFE (DuPont® T30N) was added as a dilute 30% solids solution to achieve a 3% additive level in the dispersion/slurry.

A cathode decal was prepared by casting onto a 200LP PFA film with a 15-mil rod, air-dried for 45 minutes at ambient temperature and for 1 hour in an oven at 120° F. The resulting cathode film had a thickness of 1.3 mil and a metal loading of 1.23 mg/cm² as measured by XRF.

Anode-1: A 3.5 wt % Nafion® solution in FC-40 Fluorinert™ brand electronic liquid perfluorinated solvent (the polymer resin had a 830 EW measured by FTIR and was in the sulfonyl fluoride form) was concentrated to 7% by placing it in a rotovap and removing the FC-40 solvent until a desired 7 wt % solids was obtained. 201.4 grams of 7 wt % Nafion® solution was then placed in a hot water bath to keep the solution flowable. 33 grams of an electrocatalyst comprised of platinum/ruthenium metal supported on particulate carbon (75 wt % metal/25 wt % carbon) was added to the Nafion® solution and mixed well by hand to make a slurry with 20 wt % solids. The electrocatalyst was comprised of 49.8 wt % platinum, 24.5 wt % ruthenium, and about 25 wt % particulate carbon. The electrocatalyst had a surface area of 217 m²/g and a pore volume of 0.50 cc/g (both measured according to standard nitrogen BET). The moisture content of the electrocatalyst, measured by thermo gravametric analysis using a TA Instruments TGA, was 1.7% and the initial particle size distribution, measured by LS 13 320 Laser Diffraction Particle Size Analyzer, was as follows: d₁₀=12.1 microns, d₅₀=75.3 microns, d₉₀=170.6 microns. The surface area of the platinum/ruthenium metal in the electrocatalyst was greater than 100 m²/g of metal.

The Nafion®/electrocatalyst slurry was then placed into an Eiger mill containing 40 ml of 1.0-1.25 mm zirconia grinding media and was milled at 4000 rpm for 2 hours. The Eiger mill was heated using a circulating bath set at 50° C. to ensure that the ink flowed easily. Material was withdrawn from the mill and particle size measured using a Hegman gauge. The largest particle size detected was less than 4 microns. The ink was then removed from the Eiger mill. The solid content and the viscosity of the ink were measured and they were 22.5 wt % and 93,000 centipoise respectively. The solids content of the ink was reduced to 21.5 wt % by adding additional FC-40 to produce an ink with a viscosity of 43,000 centipoise. The ink had a maximum Pt/Ru particle size of less than 4 microns.

An AMI screen printer model 9155 was used to screen print a 25 cm2 pattern of the ink on Kapton® polyimide film. A squeeze with durometer in the range of 90-100 was used for screen printing. The other screen printing parameters used were a mesh screen of about 105 with emulsion thickness of about 0.5 mil. The displacement and snap-off distances were about 300 microns and 0.090 micron respectively. The printing speed was adjusted so as to obtain the Pt/Ru metal loading of 2.1 mg/cm². The ink was dried at room temperature over night (>12 hours).

Anode-2: A 3.5 wt % Nafion® solution in FC-40 Fluorinert™ brand electronic liquid perfluorinated solvent (the polymer resin had a 830 EW measured by FTIR and was in the sulfonyl fluoride form) was concentrated to 7% by placing it in a rotovap and removing the FC-40 solvent until desired solid of 7 wt % was obtained. 201.4 grams of 7 wt % Nafion® solution was then placed in a hot water bath to keep the Nafion® in liquid form. 33 grams of an electrocatalyst comprised of platinum/ruthenium metal supported on particulate carbon (75 wt % metal/25 wt % carbon) was added to the Nafion® solution and mixed well by hand to make a slurry with 20 wt % solids. The electrocatalyst was comprised of 49.8 wt % platinum, 24.5 wt % ruthenium, and about 25 wt % particulate carbon. The electrocatalyst had a surface area of 217 m²/g and a pore volume of 0.50 cc/g (both measured according to standard nitrogen BET). The moisture content of the electrocatalyst, measured by thermo gravametric analysis using a TA Instruments TGA, was 1.7% and the initial particle size distribution, measured by LS 13 320 Laser Diffraction Particle Size Analyzer, was as follows: d₁₀=12.1 microns, d₅₀=75.3 microns, d₉₀=170.6 microns. The surface area of the platinum/ruthenium metal in the electrocatalyst was greater than 100 m²/g of metal.

The Nafion®/electrocatalyst slurry was then placed into an Eiger mill containing 40 ml of 1.0-1.25 mm zirconia grinding media and was milled at 4000 rpm for 2 hours. The Eiger mill was heated using a circulating bath set at 50° C. to ensure that the ink flowed easily. Material was withdrawn from the mill and particle size measured using a Hegman gauge. The largest particle size detected was less than 4 microns. The ink was then removed from the Eiger mill. The solid content and the viscosity of the ink were measured and they were 21.5 wt % and 31,500 centipoise respectively. The electrocatalyst ink used was further concentrated to obtain a solids content and the viscosity of 19.5 wt % and 19,500 centipoise respectively.

A catalyst electrode decal was prepared by drawing down the catalyst ink to a dimension of 5 cm×5 cm (to give a total area of 25 cm²) on a 10 cm×10 cm piece of 3 mil thick Kapton® polyimide film. A Pt/Ru metal loading of 2.0 mg/cm² was achieved by knife drawdown coating with this ink. The dry coating thickness of about 2.2 mil.

Anode-3: The electrocatalyst ink used to produce Anode-2 was used to produce another catalyst electrode decal by drawing down the catalyst ink to a dimension of 5 cm×5 cm (to give a total area of 25 cm²) on a 10 cm×10 cm piece of 3 mil thick Kapton® polyimide film. A Pt/Ru metal loading of 1.0 mg/cm² was achieved by knife drawdown coating with this ink. The dry coating thickness was about 0.93 mil.

Anode-4: The electrocatalyst ink used to produce Anode 1 was used to flexographically print another 25 cm² catalyst electrode decal on a piece of Kapton® polyimide film. A Pt/Ru loading of the decal was 2.5 mg/cm² and the decal was dried at ambient temperature. The ink was dried at room temperature over night (>12 hours).

Anode-5: The electrocatalyst ink used to produce Anode 1 was used to flexographically print another 25 cm² catalyst electrode decal on a piece of Kapton® polyimide film. A Pt/Ru loading of the decal was 2.4 mg/cm² and the decal was dried at ambient temperature. The ink was dried at room temperature over night (>12 hours).

Anode-6: 32.65 grams of Nafion® 920 EW dispersion in proton form (DuPont DE2020, 21.3% solids) and a mixture of 32.86 grams of isopropyl alcohol and 18.50 grams normal propyl alcohol were added to a beaker which was immersed in an ice bath. The beaker was in a nitrogen purged box in a hood. The dispersion was chilled to 6 C. 15.99 grams grams of an electrocatalyst comprised of platinum/ruthenium metal supported on particulate carbon (75 wt % metal/25 wt % carbon) was slowly added to the Nafion® dispersion and mixed well to make a slurry. The electrocatalyst was comprised of 49.8 wt % platinum, 24.5 wt % ruthenium, and about 25 wt % particulate carbon. The electrocatalyst had a surface area of 217 m²/g and a pore volume of 0.50 cc/g (both measured according to standard nitrogen BET). The moisture content of the electrocatalyst, measured by thermo gravametric analysis using a TA Instruments TGA, was 1.7% and the initial particle size distribution, measured by Beckman Coulter Model LS 13 320 Laser Diffraction Particle Size Analyzer, was as follows: d₁₀=12.1 microns, d₅₀=75.3 microns, d₉₀=170.6 microns. The surface area of the platinum/ruthenium metal in the electrocatalyst was greater than 100 m²/g of metal. The stirring of the slurry/dispersion was continued for about 30 minutes. After this time, the stirring was stopped and the beaker was removed from the ice bath. The dispersion was allowed to warm to ambient temperature. The dispersion was sonicated for 20 minutes using a Branson Sonifier 450 with a 0.5 inch probe at 70% power that give a 35% power output until the D₅₀ particle size was reduced to 2.5 microns, as measured with the laser diffraction particle size analyzer referenced above. To this dispersion, 59.36 grams of a solution (44 grams of isopropyl alcohol, 44 grams of normal propyl alcohol, 12 grams of water and 11.1 grams of diprolyleneglycolmonomethyl ether (DPM)) until the solids content was reduced to 16% by weight.

An anode decal was prepared on a 2-mil PFA film with a 15 mil rod. The film was air-dried at ambient temperature for 60 minutes. The resulting anode had a thickness of 1.43 mils and a total metal loading (Pt plus Ru) of 1.94 mg/cm² as measured by XRF.

### Process for Making Catalyst Coated Membranes

Catalyst coated membranes were produced using a wet piece of Nafion® N117 proton exchange membrane in which about 90% of the of the total number of univalent atoms in the polymer are fluorine atoms and having a thickness of about 7 mil and a size of about 4 inch×4 inch. For each example (except for Example 4 described below), a membrane was sandwiched between one of the anode electrode decals described above on one side of the membrane and one of the cathode electrode decals described above on opposite side of the membrane. Care was taken to ensure that the coatings on the two decals were registered with each other and were positioned facing the membrane. The entire assembly was introduced between two preheated (to about 160° C.) 8 inch×8 inch plates of a hydraulic press and the plates of the press were brought together quickly until a pressure of 5000 lbs was reached. The sandwich assembly was kept under pressure for approximately 4 minutes and then the press was cooled until it reached a temperature of <60° C. under the same pressure. Then the assembly was removed from the press and the Kapton® films were slowly peeled off the electrodes on both sides of the membrane showing that the anode and cathode electrodes had been transferred to the membrane. Each catalyst coated membrane was immersed in a tray of water (to ensure that the membrane was completely wet) and carefully transferred to a zipper bag for storage and future use.

The CCMs were chemically treated in order to convert the SO₂F groups in the ionomer in the anode and cathode electrodes to the H+ acid form. This required a hydrolysis treatment followed by an acid exchange procedure. The hydrolysis of the CCMs was carried out in a 30 wt % NaOH solution at 80° C. for 30 minutes. The CCMs were placed between Teflon® mesh, (obtained from DuPont, Wilmington, Del.), and placed in the solution. The solution was stirred to assure uniform hydrolysis. After 30 minutes in the bath, the CCMs were removed and rinsed completely with fresh deionized water to remove all the NaOH.

Acid exchange of the CCMs that were hydrolyzed in the previous step was done in 15 wt % nitric acid solution at a bath temperature of 65° C. for 45 minutes. The solution was stirred to assure uniform acid exchange. This procedure was repeated in a second bath containing 15 wt % nitric acid solution at 65° C. and for 45 minutes. The CCMs were then rinsed in flowing deionized water for 15 minutes at room temperature to ensure removal of all the residual acid. They were then packaged wet and labeled.

In Example 4, the anode and cathode electrodes were made with a binder in sulfonic acid form, so hydrolysis and acid exchange steps were not used. Catalyst Coated membranes were fabricated by anode and decal transfer to wet Nafion® N115 proton exchange membrane in the sulfonic acid form and having a thickness of 5 mil. The membrane was sandwiched between the anode electrode decal and the cathode electrode decal as described above. Care was taken to ensure that the coatings on the two decals were registered with each other and were positioned facing the membrane. The assembly was introduced between two heated plates at about 125° C. for about 5 minutes under approximately 5000 load pounds. The pressure was maintained while the press was cooled for approximately 3 minutes (until it reached a temperature of <90° C.). The assembly was removed from the press and the support films were slowly peeled off the electrodes on both sides of the membrane showing that the anode and cathode electrodes had been transferred to the membrane. Each catalyst coated membrane was immersed in a tray of water (to ensure that the membrane was completely wet) and carefully transferred to a zipper bag for storage and future use.

CCM performance measurements were made employing a single cell test assembly obtained from Fuel Cell Technologies Inc, N. Mex. Membrane electrode assemblies were made that comprised one of the above CCMs sandwiched between two sheets of the gas diffusion backing (taking care to ensure that the GDB covered the electrode areas on the CCM). The anode gas diffusion backing was comprised an 8 mil thick carbon paper coated with a 1.7 mil thick microporous carbon powder coating. The cathode diffusion backing comprised an 8 mil thick nonwoven carbon fabric with a PTFE coating (FCX0026 from Freudenberg). The microporous layer on the anode-side GDB was disposed toward the anode catalyst. Two 7 mil thick glass fiber reinforced silicone rubber gaskets (Furan—Type 1007, obtained from Stockwell Rubber Company) each along with a 1 mil thick FEP polymer spacer were cut to shape and positioned so as to surround the electrodes and GDBs on the opposite sides of the membrane and to cover the exposed edge areas of each side of the membrane. Care was taken to avoid overlapping of the GDB and the gasket material. The entire sandwich assembly was assembled between the anode and cathode flow field graphite plates of a 25 cm² standard single cell assembly (obtained from Fuel Cell Technologies Inc., Los Alamos, N. Mex.). The test assembly was also equipped with anode inlet, anode outlet, cathode gas inlet, cathode gas outlet, aluminum end blocks, tied together with tie rods, electrically insulating layer and the gold plated current collectors. The bolts on the outer plates of the single cell assembly were tightened with a torque wrench to a force of 2 ft.lbs.

The single cell assembly was then connected to the fuel cell test station. The components in a test station include a supply of air for use as cathode gas; a load box to regulate the power output from the fuel cell; a MeOH solution tank to hold the feed anolyte solution; a liquid pump to feed the anolyte solution to the fuel cell anode at the desired flow rate; a condenser to cool the anolyte exiting from the cell from the cell temperature to room temperature and a collection bottle to collect the spent anolyte solution.

With the cell at room temperature, 1M MeOH solution and air were introduced into the anode and cathode compartments through inlets of the cell at flow rates of 1.55 cc/min and 202 cc/min, respectively. The temperature of the single cell was slowly raised until it reached 70° C. The methanol and air feed rates were maintained proportional to the current while the resistance in the circuit was varied in steps so as to increase current. The voltage at each current step was recorded so as to produce a current vs. voltage plot for the cell. Using this plot, the current density (expressed in mW/cm²) at a voltage of 400 mVolts was determined and is reported below in Table 1.

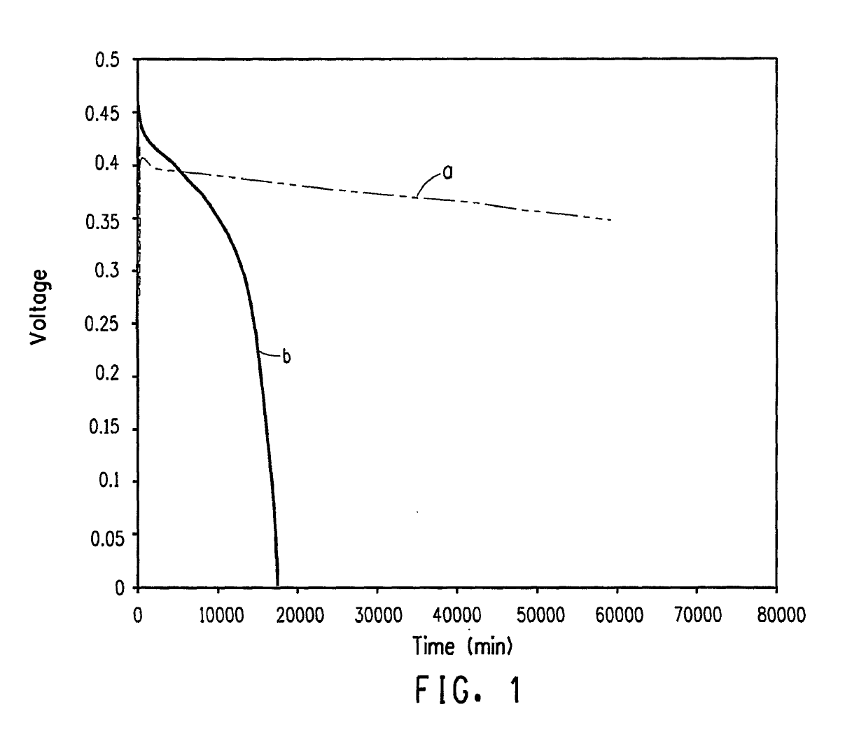

TABLE 1

| | | Anode | | Cathode | Current |
|---|---|---|---|---|---|
| | | Metals | | Metals | Density |
| | Anode | Loading | Cathode | Loading | (mW/cm²) |
| Example | Electrocatalyst | (mg/cm²) | Electrocatalyst | (mg/cm²) | @ 400 mV |
| Comparative | Anode-A | 4.5 | Cathode-D | 2.2 | 78 |
| Ex. A | (Pt/Ru | | (Pt/C | | |
| | unsupported) | | supported) | | |
| Comparative | Anode-2 | 2.0 | Cathode-A | 4.5 | 80 |
| Ex. B | (Pt/Ru/C | | (Pt | | |
| | supported) | | unsupported) | | |
| Comparative | Anode-A | 4.5 | Cathode-A | 4.5 | 100 |
| Ex. C | (Pt/Ru | | (Pt | | |
| | unsupported) | | unsupported) | | |
| Comparative | Anode-A | 4.5 | Cathode-E | 1.0 | 107 |
| Ex. D | (Pt/Ru | | (Pt/C | | |
| | unsupported) | | supported) | | |
| Comparative | Anode-B | 4.3 | Cathode-B | 5.4 | 66 |
| Ex. E | (Pt/Ru | | (Pt | | |
| | unsupported) | | unsupported) | | |
| Comparative | Anode-C | 5.1 | Cathode-C | 4.8 | 86 |
| Ex. F | (Pt/Ru | | (Pt | | |
| | unsupported) | | unsupported) | | |
| Comparative | Anode-3 | 1.0 | Cathode-A | 4.5 | 52 |
| Ex. G | (Pt/Ru/C | | (Pt | | |
| | supported) | | unsupported) | | |
| Comparative | Anode-A | 4.5 | Cathode-D | 2.2 | 78 |
| Ex. A | (Pt/Ru | | (Pt/C | | |
| | unsupported) | | supported) | | |
| Ex. 1 | Anode-1 | 2.1 | Cathode-1 | 0.63 | 86 |
| | (Pt/Ru/C | | (Pt/Co/C | | |
| | supported) | | supported) | | |
| Ex. 2 | Anode-4 | 2.5 | Cathode- 2 | 0.55 | 92 |
| | (Pt/Ru/C | | (Pt/Co/C | | |
| | supported) | | supported with | | |
| | | | Teflon ® AF) | | |
| Ex. 3 | Anode-5 | 2.4 | Cathode-3 | 0.63 | Durability |
| | (Pt/Ru/C | | (Pt/Co/C | | in FIG. 1 |
| | supported) | | supported) | | Curve a |
| Ex. 4 | Anode-6 | 1.9 | Cathode- 4 | 1.2 | 73 |
| | (Pt/Ru/C | | (Pt/Co/C | | |
| | supported) | | supported - | | |
| | | | with PTFE) | | |

A current density of 70 mW/cm² at a voltage of 400 mVolts is generally the minimum considered necessary for use in a direct methanol fuel cell. It can be seen in the examples, that this minimum level of performance is surpassed by MEAs according to the invention having anode and cathode metals loading per electrode of less than 3 mg metal/cm², and cathode loadings of even less than 1 mg metal/cm². By contrast, in the conventional MEA of Comparative Example E where both cathode and anode electrocatalysts were unsupported, metal a loading per electrode of more than 4 mg metal/cm² did not achieve the necessary minimum current density. In Comparative Example G, a supported Pt/Ru anode electrode with a relatively low 1.0 mg metal/cm² was combined with an unsupported Pt cathode electrocatalyst at a metals loading of 4.5 mg metal/cm², and the current density was below the minimum need for DMFC fuel cells. Surprisingly, with an MEA according to one embodiment of the present invention (Example 1), satisfactory current density was obtained with a total cathode and anode metals loading of less than 3 mg metal/cm². Nearly 2 times as much total catalyst metal was needed to achieve a similar performance in the conventional MEA of Comparative Example B where the cathode electrocatalyst was 4.5 mg metal/cm², and the anode electrocatalyst was 2.0 mg metal/cm². The conventional cathode loading of 4.5 mg metal/cm² was more than six times higher than was used in the cathode of Example 1 to achieve similar performance.

A long term accelerated durability test was performed on the catalyst coated membranes of Comparative Example F and Example 3. The long term durability test was conducted with the same single cell test assembly described above and the MEAs prepared by the same procedure. With the cell at room temperature, 1M MeOH solution and air were introduced into the anode and cathode compartments through inlets of the cell at flow rates of 1.55 cc/min and 202 cc/min, respectively. The temperature of the single cell was slowly raised until it reached 70° C. The initial open cell voltage (no applied load) was first detected. A resistance load was then applied so as to maintain a current of 3.75 Amps and held for 30 minutes, and the average voltage drop was measured for this period at this current. The resistance was then removed for 30 seconds before the start of the next 30 minute test cycle. During each test cycle, the resistance necessary to maintain a 3.75 Amp current was applied and the average voltage drop was measured and recorded. The cycles were continued for an extended period of time. A plot of the average voltage drop over time for the MEAs of Comparative Example F and Example 3 is shown in FIG. 1. It can be seen that the MEA of Example 3 (curve “a”) maintains its ability to achieve a voltage drop long after the conventional MEA of Comparative Example F (curve “b”) has degenerated. This improved durability has great utility in a DMFC fuel cell.

1. A membrane electrode assembly for an organic/air fuel cell comprising:
a proton exchange membrane made of a highly fluorinated ion-exchange polymer, said membrane having opposite first and second sides;
an anode electrode adjacent said first side of the membrane, said anode electrode comprised of 50 to 90 wt % of an anode electrocatalyst and 10 to 50 wt % of a highly fluorinated ion-exchange polymer binder, said anode electrocatalyst being comprised of an anode metal supported on carbon, wherein the anode metal is comprised of platinum and ruthenium and the carbon is particulate carbon, said anode electrocatalyst being comprised of at least 30 wt % platinum, at least 15 wt % ruthenium, and 15 to 50 wt % particulate carbon;
a cathode electrode adjacent said second side of the membrane, said cathode electrode comprised of 50 to 90 wt % of a cathode electrocatalyst and 10 to 50 wt % of a highly fluorinated ion-exchange polymer binder, said cathode electrocatalyst being comprised of a cathode metal supported on carbon, wherein the cathode metal is comprised of platinum and cobalt and the carbon is particulate carbon, said cathode electrocatalyst being comprised of at least 30 wt % platinum, at least 1 wt % cobalt, and 15 to 60 wt % particulate carbon.

2. The membrane electrode assembly of claim 1, wherein the anode electrocatalyst consists essentially of platinum, ruthenium and particulate carbon.

3. The membrane electrode assembly of claim 2, wherein the anode electrocatalyst includes 30 to 60 wt % platinum, 20 to 40 wt % ruthenium and 20 to 50 wt % particulate carbon.

4. The membrane electrode assembly of claim 1, wherein the cathode electrocatalyst consists essentially of platinum, cobalt and particulate carbon.

5. The membrane electrode assembly of claim 1, wherein the cathode electrocatalyst includes 30 to 80 wt % platinum, 1 to 15 wt % cobalt, and 20 to 60 wt % particulate carbon.

6. The membrane electrode assembly of claim 1, wherein the cathode electrocatalyst includes 30 to 60 wt % platinum, 2 to 10 wt % cobalt, and 20 to 60 wt % particulate carbon.

7. The membrane electrode assembly of claim 1 wherein the total loading of the anode metal in the anode electrode is less than 3 mg/cm², and wherein the total loading of the cathode metal in the cathode electrode is less than 2 mg/cm².

8. The membrane electrode assembly of claim 1 wherein the total loading of the anode metal in the anode electrode is less than 2.5 mg/cm², and wherein the total loading of the cathode metal in the cathode electrode is less than 1 mg/cm².

9. The membrane electrode assembly of claim 8 wherein the total loading of the cathode metal in the cathode electrode is less than 0.8 mg/cm².

10. The membrane electrode assembly of claim 1 wherein the sum of the total loading of anode metal in the anode electrode and cathode metal in the cathode electrode is less than 3.0 mg/cm².

11. The membrane electrode assembly of claim 1 wherein the proton exchange membrane consists essentially of a perfluorinated ionomer having sulfonic acid end groups.

12. The membrane electrode assembly of claim 11 wherein the highly fluorinated ion-exchange polymer binder in both the anode electrode and the cathode electrodes consist essentially of a perfluorinated ionomer having sulfonic acid end groups.

13. The membrane electrode assembly of claim 1 wherein the anode and cathode electrodes are adhered directly to the opposite first and second sides of the proton exchange membrane.

14. The membrane electrode assembly of claim 13 wherein the proton exchange membrane consists essentially of a perfluorinated ionomer having sulfonic acid end groups, and wherein the highly fluorinated ion-exchange polymer binder in both the anode electrode and the cathode electrodes consist essentially of a perfluorinated ionomer having sulfonic acid end groups.

15. The membrane electrode assembly of claim 1 further comprising
a first electrically conductive gas diffusion substrate disposed on the first side of the proton exchange membrane, said anode electrode being disposed between said first conductive gas diffusion substrate and the first side of the proton exchange membrane, wherein said anode electrode is adhered to the first conductive gas diffusion substrate and is in direct contact with the first side of the proton exchange membrane, and
a second electrically conductive gas diffusion substrate disposed on the second side of the proton exchange membrane, said cathode electrode being disposed between said second conductive gas diffusion substrate and the second side of the proton exchange membrane, wherein said anode electrode is adhered to the second conductive gas diffusion substrate and is in direct contact with the second side of the proton exchange membrane.

16. The membrane electrode assembly of claim 15 wherein the proton exchange membrane consists essentially of a perfluorinated ionomer having sulfonic acid end groups, and wherein the highly fluorinated ion-exchange polymer binder in both the anode electrode and the cathode electrodes consist essentially of a perfluorinated ionomer having sulfonic acid end groups.

17. The membrane electrode assembly of claim 15, wherein the electrically conductive gas diffusion substrate is a carbon-fiber based paper or cloth.

18. The membrane electrode assembly of claim 1, wherein the particulate carbon is from the group of turbostratic or graphitic carbons.

19. The membrane electrode assembly of claim 1, wherein said cathode electrode further comprises a hydrophobic additive.

20. The membrane electrode assembly of claim 1, wherein said cathode electrode further comprises from about 1.5 to about 15 weight percent of a highly fluorinated hydrophobic agent, based on the total weight of the electrocatalyst.

21. The membrane electrode assembly of claim 20, wherein said highly fluorinated hydrophobic agent is selected from the group of crystalline and amorphous fluoropolymers.

22. An organic/air fuel cell comprising the membrane electrode assembly of claim 1.

23. A process for producing a membrane electrode assembly for an organic/air fuel cell, comprising
(a) providing a proton exchange membrane made of a highly fluorinated ion-exchange polymer, said membrane having opposite first and second sides;
(b) forming an anode electrode adjacent said first side of the membrane, said anode electrode comprised of 50 to 90 wt % of an anode electrocatalyst and 10 to 50 wt % of a highly fluorinated ion-exchange polymer binder, said anode electrocatalyst being comprised of an anode metal supported on carbon, wherein the anode metal is comprised of platinum and ruthenium and the carbon is particulate carbon, said anode electrocatalyst being comprised of at least 30 wt % platinum, at least 15 wt % ruthenium, and 15 to 50 wt % particulate carbon; and
(c) forming a cathode electrode adjacent said second side of the membrane, said cathode electrode comprised of 50 to 90 wt % of a cathode electrocatalyst and 10 to 50 wt % of a highly fluorinated ion-exchange polymer binder, said cathode electrocatalyst being comprised of a cathode metal supported on carbon, wherein the cathode metal is comprised of platinum and cobalt and the carbon is particulate carbon, said cathode electrocatalyst being comprised of at least 30 wt % platinum, at least 1 wt % cobalt, and 15 to 60 wt % particulate carbon.

24. The process of claim 23, wherein forming the membrane electrode assembly for an organic/air fuel cell includes the steps of
making an anode electrocatalyst ink comprised of highly fluorinated ion-exchange polymer, anode electrocatalyst particles of the platinum and ruthenium supported on particulate carbon, and a solvent, wherein at least 98% of such anode electrocatalyst particles have a diameter of less than 10 microns,
forming the anode electrode by forming a coating of the anode electrocatalyst ink and removing the solvent from the anode electrocatalyst ink,
making a cathode electrocatalyst ink comprised of highly fluorinated ion-exchange polymer, cathode electrocatalyst particles of the platinum and cobalt supported on particulate carbon, and a solvent, wherein at least 98% of such cathode electrocatalyst particles have a diameter of less than 10 microns, and
forming the cathode electrode by forming a coating of the cathode electrocatalyst ink and removing the solvent from the cathode electrocatalyst ink.

25. The process of claim 23, wherein forming the membrane electrode assembly for an organic/air fuel cell includes the steps of
making an anode electrocatalyst ink comprised of highly fluorinated ion-exchange polymer, the platinum and ruthenium supported on particulate carbon, and a fluorinated solvent, the highly fluorinated ion-exchange polymer being a perfluorinated polymer having sulfonyl fluoride end groups,
forming the anode electrode by forming a coating of the anode electrocatalyst ink and removing the solvent from the anode electrocatalyst ink,
making a cathode electrocatalyst ink comprised of highly fluorinated ion-exchange polymer, the platinum and cobalt supported on particulate carbon, and a fluorinated solvent, the highly fluorinated ion-exchange polymer being a perfluorinated polymer having sulfonyl fluoride end groups,
forming the cathode electrode by forming a coating of the cathode electrocatalyst ink and removing the solvent from the cathode electrocatalyst ink,
applying the anode and cathode electrodes to opposite sides of the proton exchange membrane, and
converting the sulfonyl fluoride end groups in the ion-exchange polymer of the anode electrode and cathode electrode to acid end groups by a hydrolysis treatment followed by an acid exchange step.

26. The process of claim 23, wherein forming the membrane electrode assembly for an organic/air fuel cell includes the steps of
making an anode electrocatalyst ink comprised of highly fluorinated ion-exchange polymer, platinum and ruthenium supported on particulate carbon, and a fluorinated solvent, the highly fluorinated ion-exchange polymer being a perfluorinated polymer having sulfonic acid end groups,
forming the anode electrode by forming a coating of the anode electrocatalyst ink and removing the solvent from the anode electrocatalyst ink,
making a cathode electrocatalyst ink comprised of highly fluorinated ion-exchange polymer, the platinum supported on particulate carbon, and a fluorinated solvent, the highly fluorinated ion-exchange polymer being a perfluorinated polymer having sulfonic acid end groups,
forming the cathode electrode by forming a coating of the cathode electrocatalyst ink and removing the solvent from the cathode electrocatalyst ink,
applying the anode and cathode electrodes to opposite side of the proton exchange membrane, said proton exchange membrane being comprised of a highly fluorinated ion-exchange polymer in proton form.

27. A process for operating a membrane electrode assembly of an organic/air fuel cell, comprising
(a) providing a proton exchange membrane made of a highly fluorinated ion-exchange polymer, said membrane having opposite first and second sides;
(b) forming an anode electrode adjacent said first side of the membrane, said anode electrode comprised of 50 to 90 wt % of an anode electrocatalyst and 10 to 50 wt % of a highly fluorinated ion-exchange polymer binder, said anode electrocatalyst being comprised of an anode metal supported on carbon, wherein the anode metal is comprised of platinum and ruthenium and the carbon is particulate carbon, said anode electrocatalyst being comprised of at least 30 wt % platinum, at least 15 wt % ruthenium, and 15 to 50 wt % particulate carbon;
(c) forming a cathode electrode adjacent said second side of the membrane, said cathode electrode comprised of 50 to 90 wt % of a cathode electrocatalyst and 10 to 50 wt % of a highly fluorinated ion-exchange polymer binder, said cathode electrocatalyst being comprised of a cathode metal supported on carbon, wherein the cathode metal is comprised of platinum and cobalt and the carbon is particulate carbon, said cathode electrocatalyst being comprised of at least 30 wt % platinum, at least 1 wt % cobalt, and 15 to 60 wt % particulate carbon.
(d) forming an electric circuit between the anode and cathode electrodes, and
(e) feeding a organic fuel to the anode electrode and oxygen to the cathode electrode so as to generate an electric current in said electric circuit.

28. The process of claim 27 wherein the organic fuel is selected from the group of methanol, ethanol, formaldehyde, formic acid, and combinations thereof.

29. The process of claim 28 wherein the organic fuel is liquid methanol.
